(19) United States
(12) Patent Application Publication
(10) Pub. No.: US 2021/0297562 A1
(43) Pub. Date: Sep. 23, 2021

(54) SENSING POSITIONS OF MOVEABLE CAMERAS OF COMPUTING DEVICES

(71) Applicant: HEWLETT-PACKARD DEVELOPMENT COMPANY, L.P., Spring, TX (US)

(72) Inventors: Syed S Azam, Houston, TX (US); Georgios Mandamadiotis, Houston, TX (US); John Frederick, Houston, TX (US)

(21) Appl. No.: 16/481,665

(22) PCT Filed: Jul. 19, 2017
(86) PCT No.: PCT/US2017/042795

§ 371 Date: Jul. 29, 2019

(51) Int. Cl. H04N 5/225; H04N 5/232; H04N 7/14

(52) U.S. Cl. CPC H04N 5/2257; H04N 7/142; H04N 5/232

(57) ABSTRACT

A method, according to one example, includes sensing a position of a camera of a computing device, wherein the camera is moveable between a hidden position and a visible position. The method includes automatically enabling the camera via firmware when the camera is sensed as being in the visible position. The method includes automatically disabling the camera via the firmware when the camera is sensed as being in the hidden position.

### BACKGROUND

Personalized virtual interaction like video conferencing is increasingly being used to accomplish a variety of tasks, such as conducting a remote meeting. Video conferencing enables participants located at different sites to simultaneously interact via two-way video and audio transmissions. A video conference can be as simple as a conversation between two participants located at different sites or involve discussions between many participants located at different sites and may include shared presentation content such as a video presentation or slides. As high-speed network connectivity is becoming more widely available at lower cost and the cost of video capture and display technologies continues to decrease, video conferencing conducted over networks between participants in faraway places is becoming increasingly popular.

### BRIEF DESCRIPTION OF THE DRAWINGS

FIG. 1 is a block diagram illustrating elements of a computing device with a retractable camera according to one example.

FIG. 2 is a flow diagram illustrating a method for controlling a power state of a moveable camera of a computing device according to one example.

FIG. 3 is a diagram illustrating a non-transitory computer-readable storage medium according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Some examples disclosed herein involve multiple participants connected together over a network for a virtual interaction, such as a remote meeting. A remote meeting as used herein is intended to refer to an interaction between at least two participants where not all of the participants are located at the same physical location (i.e., at least one of the participants is remotely located). The participants of a remote meeting may use a portable or non-portable computing device, such as, but not limited to, a personal computer, a desktop computer, a laptop computer, a notebook computer, a network computer, a personal digital assistant (PDA), a mobile device, a hand-held device, or any other suitable computing device. Some examples involve at least one presenter and a multiple number of participants connected together over a network, such as, the Internet. It may be noted that the presenter is a “participant” in the context of a remote meeting of this nature, where he or she is interacting with other “participants”.

Computing devices involved in a remote meeting may include a retractable (e.g., pop in/out) camera, which may also include a microphone. For such a device, a user may push the camera down to a hidden position when it is not being used, and push the camera again to pop-up the camera to a visible position when it is to be used. When a retractable camera is turned on, a user may physically push down the camera, which may result in the camera and microphone being physically blocked, but not turned off. Thus, even when the camera and/or microphone are hidden, they may continue to function to a degree that introduces a less than ideal experience and a real security issue. For example, if the camera is pushed down to the hidden position and remains turned on, the camera may not transmit useful images due to the lens being physically blocked, but a microphone in the camera may still be listening and transmitting audio information. Since the camera is still enumerated as being an active device in this situation, any communication software may continue to access the camera and microphone while the camera is in the hidden position.

Another issue that can arise is when a user receives an incoming video call and wants to use the camera and microphone. In such a case, the user may have to manually push the camera into the pop out position before any useful images can be communicated.

Some examples disclosed herein sense the physical position of the camera and communicate this information to a software application to control a power state of the camera, which enhances security and the user experience, and reduces battery usage. Some examples are directed to controlling the power state of a microphone and a retractable camera of a computing device based on the physical position of the camera. The camera may be moved between a retracted or hidden position, and an extended or visible position. A sensor detects whether the camera is in the hidden position or the visible position. When the sensor detects that the camera has been moved to the hidden position, the camera and microphone are turned off in firmware, which results in the camera and microphone not being detectable by the operating system of the computing device. When the sensor detects that the camera has been moved to the visible position, the camera and microphone are turned on in firmware. “Firmware” as used herein refers to machine readable instructions stored in a non-volatile memory of a device to provide low level control of the device. In some examples, the computing device causes the camera to be automatically switched to the visible position when an incoming call is accepted, and causes the camera to be automatically switched to the hidden position when the call has terminated.

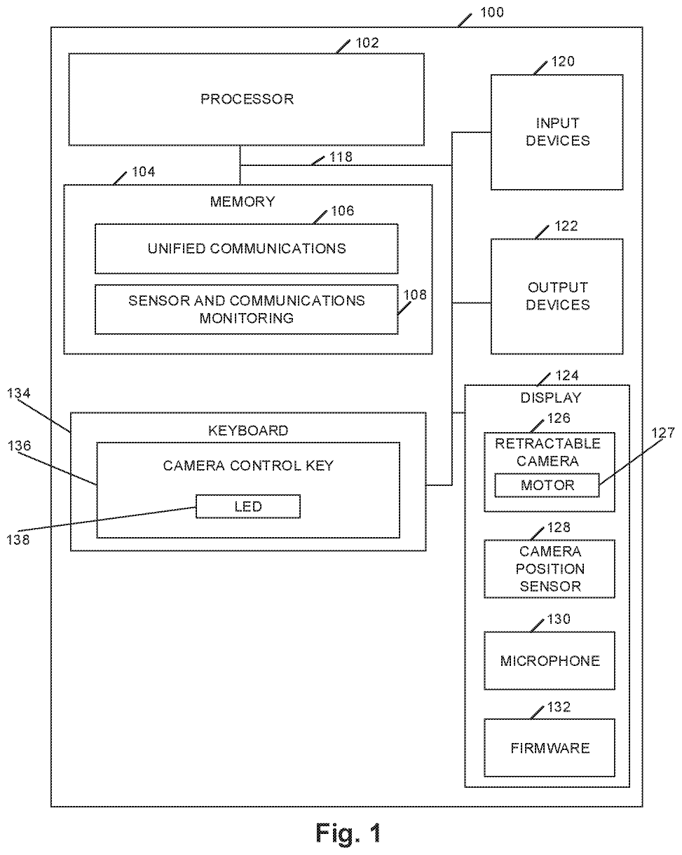

FIG. 1 is a block diagram illustrating elements of a computing device 100 with a retractable camera according to one example. Computing device 100 includes a processor 102, a memory 104, input devices 120, output devices 122, display 124, and keyboard 134. Processor 102, memory 104, input devices 120, output devices 122, display 124, and keyboard 134 are communicatively coupled to each other through communication link 118. Display 124 includes retractable camera 126, camera position sensor 128, microphone 130, and firmware 132. In some examples, retractable camera 126 includes a motor 127. Keyboard 134 includes a camera control key 136 with an associated light emitting diode (LED) 138.

Input devices 120 include a mouse, data ports, and/or other suitable devices for inputting information into device 100. Output devices 122 include speakers, data ports, and/or other suitable devices for outputting information from device 100.

Processor 102 includes a Central Processing Unit (CPU) or another suitable processor. In one example, memory 104 stores machine readable instructions executed by processor 102 for operating device 100. Memory 104 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 104 is non-transitory in the sense that it does not encompass a transitory signal but instead is made up of a memory component to store machine executable instructions for performing techniques described herein.

Memory 104 stores unified communications module 106 and sensor and communications monitoring module 108. Processor 102 executes instructions of modules 106 and 108 to perform the techniques described herein. It is noted that some or all of the functionality of modules 106 and 108 may be implemented using cloud computing resources.

Unified communications module 106 allows the user of computing device 100 to participate in a remote meeting. As one example, module 106 may be a Skype software application. During the remote meeting, camera 126 captures video images of the user of computing device 100, and microphone 130 captures audio information from the user. Module 106 may cause the captured video images and audio information to be transmitted as video streams and audio streams to other participants of the remote meeting. Module 106 also receives input audio streams and corresponding video streams associated with other participants. These audio streams and video streams may be generated on systems that are located at each of the physical locations of the other participants. Module 106 outputs the received audio streams and video streams to the display 124. In this way, each of the participants within a virtual environment can participate in a communication session although they may be physically located in remote locations.

In some examples, the camera 126 may be moved between a retracted or hidden position, and an extended or visible position. In other examples, the camera 126 may be integrated into the bezel of the display 124, and a manually-controlled or electrically-controlled sliding cover may be used to switch the camera 126 between a hidden state or position and a visible state or position (i.e., closing the cover causes the camera 126 to be in the hidden state, and opening the cover causes the camera 126 to be in the visible state). Camera position sensor 128 senses whether the camera 126 is in the hidden state or position or the visible state or position, and may send the sensed position information to module 108. In some examples, when the sensor 128 senses that the camera 126 has been switched from the visible position to the hidden position, the sensor 128 causes the display firmware 132 to turn off the camera 126 and the microphone 130. When the sensor 128 senses that the camera 126 has been switched from the hidden position to the visible position, the sensor 128 causes the display firmware 132 to turn on the camera 126 and the microphone 130.

In some examples, turning off the camera 126 and microphone 130 via firmware 132 results in the camera 126 and microphone 130 not being detectable by the operating system of the computing device 100. Disabling the camera 126 and microphone 130 in this manner is essentially the same as physically removing these devices from the computing device 100 in that software applications are unable to access these devices or even know that they are present. In some examples, the commands that are sent to the firmware 132 to control the camera 126 and the microphone 130 are encrypted and include a digital signature, and the firmware 132 ignores any such commands if they are not properly encrypted or do not include a proper digital signature. Using encryption and signature verification in this manner helps to prevent the firmware 132 from being hacked in a manner that would allow a rogue application to improperly access the camera 126 and microphone 130.

In some examples, the camera 126 and the microphone 130 may be automatically powered off when the camera 126 is moved to the hidden position, which helps to prevent hacking of the camera 126 and the microphone 130. The camera 126 and the microphone 130 may be automatically powered on when the camera 126 is moved to the visible position, and the camera 126 and the microphone 130 may be made available for use by the system. Removing and restoring power for the camera 126 and the microphone 130 may be done by a mechanical switch or by firmware 132. Rather than turning off the camera 126 and the microphone 130, these devices may be disabled in another manner, such as by putting these devices in a standby state or a low-power state, or disabling a USB connection. Similarly the camera 126 and the microphone 130 may be enabled by switching them out of the standby state or low-power state, or enabling a USB connection.

In other examples, module 108 continually monitors the sensed position information provided by sensor 128, and when the sensed position information indicates that the camera 126 has been moved from the visible position to the hidden position, the module 108 causes the camera 126 and the microphone 130 to be turned off via the firmware 132. When the sensed position information indicates that the camera 126 has been moved from the hidden position to the visible position, the module 108 causes the camera 126 and the microphone 130 to be turned on via the firmware 132.

In yet other examples, module 108 continually monitors the sensed position information provided by sensor 128, and when the sensed position information indicates that the camera 126 has been moved from the visible position to the hidden position, the module 108 causes the camera 126 and the microphone 130 to be turned off via the firmware 132, and informs the unified communications module 106 that the camera 126 and the microphone 130 are not available for use by the module 106. The module 106 may then allow a user to select a different camera and/or microphone. When the sensed position information indicates that the camera 126 has been moved from the hidden position to the visible position, the module 108 causes the camera 126 and the microphone 130 to be turned on via the firmware 132, and informs the unified communications module 106 that the camera 126 and the microphone 130 are available for use by the module 106.

In some examples, sensor and communications monitoring module 108 continually monitors the unified communications module 106 for an active or incoming video or audio call. When module 108 determines that an incoming video or audio call has been accepted by a user, or that an active call is in progress, module 108 causes the camera 126 and the microphone 130 to be turned on, and causes the motor 127 to automatically drive the camera 126 from the hidden position into the visible position. When module 108 determines that an active call has been terminated, module 108 causes the camera 126 and the microphone 130 to be turned off, and causes the motor 127 to automatically drive the camera 126 from the visible position to the hidden position. In other examples, rather than using a motor 127, the camera 126 may be spring loaded, and the device 100 may use an electro-mechanical release that allows the spring loaded camera 126 to automatically move to the visible position. In yet other examples, a sliding cover may be used to switch the camera 126 between the visible position and the hidden position.

In some examples, sensor and communications monitoring module 108 continually monitors the unified communications module 106 for an active or incoming video or audio call. When module 108 determines that an incoming video or audio call has been accepted by a user, or that an active call is in progress, module 108 causes the LED 138 of the camera control key 136 to be turned on (and may cause the LED 138 to repeatedly flash on and off), which provides an indication to the user to take action to change the position of the camera 126. Pressing the camera control key 136 at this point causes the camera 126 and the microphone 130 to be turned on, and causes the motor 127 to automatically drive the camera 126 from the hidden position into the visible position. Module 108 then causes the LED 138 to be turned off. When module 108 determines that an active call has been terminated, module 108 causes the LED 138 of the camera control key 136 to be turned on (and may cause the LED 138 to repeatedly flash on and off), which provides an indication to the user to take action to change the position of the camera 126. Pressing the camera control key 136 at this point causes the camera 126 and the microphone 130 to be turned off, and causes the motor 127 to automatically drive the camera 126 from the visible position to the hidden position. Module 108 then causes the LED 138 to be turned off.

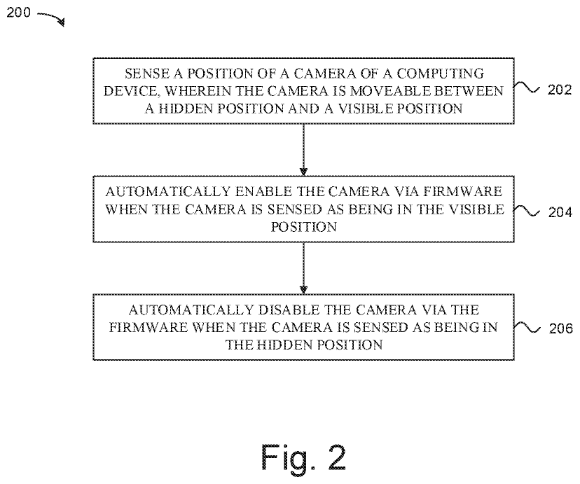

One example is directed to a method for enabling and disabling a moveable camera. FIG. 2 is a flow diagram illustrating a method 200 for enabling and disabling a moveable camera of a computing device according to one example. In one example, computing device 100 (FIG. 1) may perform method 200. At 202 in method 200, a position of a camera of a computing device is sensed, wherein the camera is moveable between a hidden position and a visible position. At 204, the camera is automatically enabled via firmware when the camera is sensed as being in the visible position. At 206, the camera is automatically disabled via the firmware when the camera is sensed as being in the hidden position.

The method 200 may further include automatically enabling a microphone of the computing device via the firmware when the camera is sensed as being in the visible position; and automatically disabling the microphone via the firmware when the camera is sensed as being in the hidden position. The disabling of the camera via the firmware may cause the camera to not be detectable by an operating system of the computing device. The disabling of the camera via the firmware may prevent software applications from accessing the camera. The firmware may be display firmware of a display of the computing device.

The sensing of the position of the camera may be performed by a sensor, and the method 200 may further include sending position information from the sensor to a first module of the computing device; and controlling the firmware, with the first module, to turn the camera on and off. The method 200 may further include providing a notification from the first module to a unified communications module that indicates whether the camera is available for use by the unified communications module for a remote meeting. The method 200 may further include monitoring, with the first module, a unified communications module for an incoming call; and controlling the firmware, with the first module, to turn the camera on when a user accepts the incoming call. The method 200 may further include causing, with the first module, a motor to drive the camera from the hidden position to the visible position when the user accepts the incoming call. The method 200 may further include controlling the firmware, with the first module, to automatically turn the camera off when the accepted incoming call has been terminated; and causing, with the first module, a motor to drive the camera from the visible position to the hidden position when the accepted incoming call has been terminated. The method 200 may further include monitoring, with the first module, a unified communications module for an incoming call; and causing, with the first module, a keyboard of the computing device to provide a notification to a user when the user accepts the incoming call, wherein the notification notifies the user to press a camera control key on the keyboard.

Another example is directed to a display, which includes a camera that is switchable between a hidden state and a visible state, and a sensor to sense a current state of the camera and provide an indication of whether the camera is in the hidden state or the visible state. The display may include a processor to control firmware of the display to cause the camera to be enabled and disabled based on the sensed current state of the camera. The display may further include a microphone, and the processor may control the firmware to cause the microphone to be enabled and disabled based on the sensed current state of the camera.

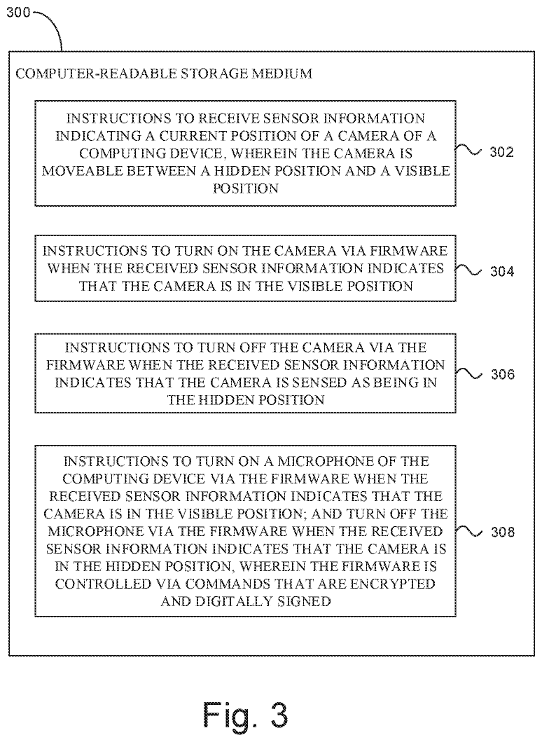

Yet another example is directed to a non-transitory computer-readable storage medium. FIG. 3 is a diagram illustrating a non-transitory computer-readable storage medium 300 according to one example. Non-transitory computer-readable storage medium 300 stores instructions 302-306 that, when executed by a processor, cause the processor to: receive sensor information indicating a current position of a camera of a computing device, wherein the camera is moveable between a hidden position and a visible position, as shown at 302; turn on the camera via firmware when the received sensor information indicates that the camera is in the visible position, as shown at 304; and turn off the camera via the firmware when the received sensor information indicates that the camera is in the hidden position, as shown at 306. The non-transitory computer-readable storage medium may further store instructions 308 that, when executed by the processor, cause the processor to: turn on a microphone of the computing device via the firmware when the received sensor information indicates that the camera is in the visible position; and turn off the microphone via the firmware when the received sensor information indicates that the camera is in the hidden position, wherein the firmware is controlled via commands that are encrypted and digitally signed, as shown at 308.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
sensing a position of a camera of a computing device, wherein the camera is moveable between a hidden position and a visible position;
automatically enabling the camera via firmware when the camera is sensed as being in the visible position; and
automatically disabling the camera via the firmware when the camera is sensed as being in the hidden position.

2. The method of claim 1, and further comprising:
automatically enabling a microphone of the computing device via the firmware when the camera is sensed as being in the visible position; and
automatically disabling the microphone via the firmware when the camera is sensed as being in the hidden position.

3. The method of claim 1, wherein the disabling of the camera via the firmware causes the camera to not be detectable by an operating system of the computing device.

4. The method of claim 1, wherein the disabling of the camera via the firmware prevents software applications from accessing the camera.

5. The method of claim 1, wherein the firmware is display firmware of a display of the computing device.

6. The method of claim 1, wherein the sensing the position of the camera is performed by a sensor, and wherein the method further comprises:
sending position information from the sensor to a first module of the computing device; and
controlling the firmware, with the first module, to turn the camera on and off.

7. The method of claim 6, and further comprising:
providing a notification from the first module to a unified communications module that indicates whether the camera is available for use by the unified communications module for a remote meeting.

8. The method of claim 6, and further comprising:
monitoring, with the first module, a unified communications module for an incoming call; and
controlling the firmware, with the first module, to turn the camera on when a user accepts the incoming call.

9. The method of claim 8, and further comprising:
causing, with the first module, a motor to drive the camera from the hidden position to the visible position when the user accepts the incoming call.

10. The method of claim 8, and further comprising:
controlling the firmware, with the first module, to automatically turn the camera off when the accepted incoming call has been terminated; and
causing, with the first module, a motor to drive the camera from the visible position to the hidden position when the accepted incoming call has been terminated.

11. The method of claim 6, and further comprising:
monitoring, with the first module, a unified communications module for an incoming call; and
causing, with the first module, a keyboard of the computing device to provide a notification to a user when the user accepts the incoming call, wherein the notification notifies the user to press a camera control key on the keyboard.

12. A display, comprising:
a camera that is switchable between a hidden state and a visible state;
a sensor to sense a current state of the camera and provide an indication of whether the camera is in the hidden state or the visible state; and
a processor to control firmware of the display to cause the camera to be enabled and disabled based on the sensed current state of the camera.

13. The display of claim 12, and further comprising:
a microphone; and
wherein the processor controls the firmware to cause the microphone to be enabled and disabled based on the sensed current state of the camera.

14. A non-transitory computer-readable storage medium storing instructions that, when executed by a processor, cause the processor to:
receive sensor information indicating a current position of a camera of a computing device, wherein the camera is moveable between a hidden position and a visible position;
turn on the camera via firmware when the received sensor information indicates that the camera is in the visible position; and
turn off the camera via the firmware when the received sensor information indicates that the camera is in the hidden position.

15. The non-transitory computer-readable storage medium of claim 14, and further storing instructions that, when executed by the processor, cause the processor to:
turn on a microphone of the computing device via the firmware when the received sensor information indicates that the camera is in the visible position; and
turn off the microphone via the firmware when the received sensor information indicates that the camera is in the hidden position, wherein the firmware is controlled via commands that are encrypted and digitally signed.
